(19) United States
(12) Patent Application Publication
(10) Pub. No.: US 2011/0205038 A1
(43) Pub. Date: Aug. 25, 2011

(54) DEVICE FOR HAPTIC FEEDBACK CONTROL

(75) Inventors: Xavier Drouin, Annemasse (FR); Patrice Laurent, Annemasse (FR)

(73) Assignee: DAV, Creteil (FR)

(21) Appl. No.: 13/054,250

(22) PCT Filed: Jul. 21, 2009
(86) PCT No.: PCT/EP2009/059386

§ 371 Date: May 5, 2011

(30) Foreign Application Priority Data
Jul. 21, 2008 (FR) 0804131

(51) Int. Cl. G08B 6/00

(52) U.S. Cl. 340/407.2

(57) ABSTRACT

The invention relates to a device for haptic feedback control, that comprises a bearing plate (3) for transmitting a haptic feedback to a user's finger in a circular movement area of said finger, a touch-surface sensor (5) for detecting a bearing of said finger in said area, characterised in that the device comprises first and second actuators (7a, 7b) connected to said plate (3) for applying a rotation torque (C) to said plate (3) for generating the haptic feedback in said area when a bearing is detected, by the pivotal movement of said plate (3) about a rotation axis (I) that is coaxial with the centre of the movement area of said finger.

The present invention relates to a device for haptic feedback control comprising a backing plate capable of transmitting a haptic feedback, such as a vibration, to a user for example after the modification or selection of a command.

The control devices comprise a backing plate connected to actuators in order to transmit a haptic feedback to a finger of a user in a zone of movement of the finger.

Therefore, when a pressure of a finger is detected in the zone of movement, the actuators cause the plate to vibrate in translation.

In the case of the devices comprising a circular-shaped zone of movement of the finger, it may happen that the haptic feedback is not felt uniformly over the whole zone of movement of the finger by the user.

The object of the present invention is therefore to propose a device for haptic feedback control which does not have the drawbacks of the prior art.

Accordingly, the subject of the invention is a device for haptic feedback control comprising a backing plate for transmitting a haptic feedback to a finger of a user in a circular-shaped zone of movement of said finger, a touch-sensitive surface sensor for detecting a pressure of said finger in said zone, characterized in that it comprises a first and a second actuator connected to said plate in order to apply a rotary torque to said plate in order to generate the haptic feedback in said zone when a pressure is detected, by a pivoting movement of said plate about an axis of rotation, coaxial with the center of said zone of movement of said finger.

Therefore, the feeling obtained is uniform for the user in the whole zone of movement of the finger and the axis of rotation has no material axis, which makes it possible to limit the interference noise.

According to one or more features of the invention, taken alone or in combination,
said plate has a circular or annular shape,
said actuators are placed in a diametrically opposed manner,
one of the two connections between said plate and the movable portion of the actuator comprises an operating clearance in radial translation,
said control device comprises means for connection between said plate and the movable portion of the actuators made of a plastic material; the compliance of the plastic material is sufficient to absorb the deformations of the connections between the plate and the supports of the respective actuators and makes it possible to limit the interference noise when the plate pivots,
said control device comprises a processing unit connected to said sensor and configured to determine the direction of an elementary movement of said finger based on the signals originating from said sensor, and for modulating at least one control parameter of at least one actuator, so that the resultant of the vibratory effect generated by said actuator is felt by said finger in one and the same direction and substantially in the opposite direction to the direction of said elementary movement,
said control parameter is modulated so that the actuator moves at a higher speed in the opposite direction to the elementary movement than in the direction of the elementary movement,
said movement sensor comprises a touch-sensitive surface sensor supported by the backing plate in the zone of movement of said finger,
said control device comprises a touch-sensitive surface pressure sensor such as a touch-sensitive surface pressure sensor of the FSR type.

Other advantages and features will appear on reading the description of the invention and the appended drawings in which:

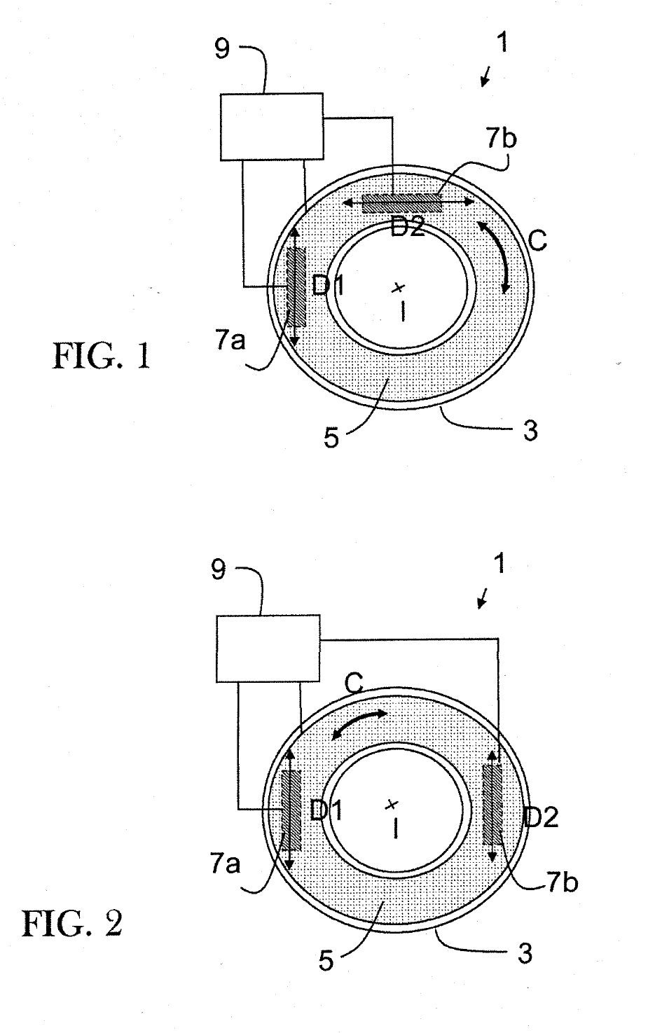

FIG. 1 is a schematic view of a control device made according to a first embodiment,

FIG. 2 is a schematic view of a control device made according to a second embodiment,

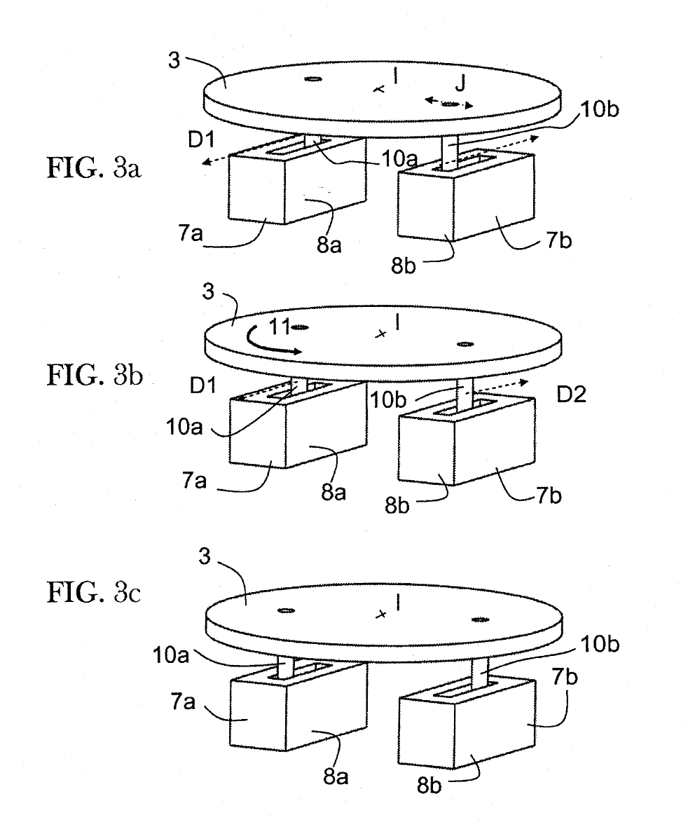

FIGS. 3a, 3b and 3c are views of a control device in operation corresponding to the embodiment of FIG. 2, and

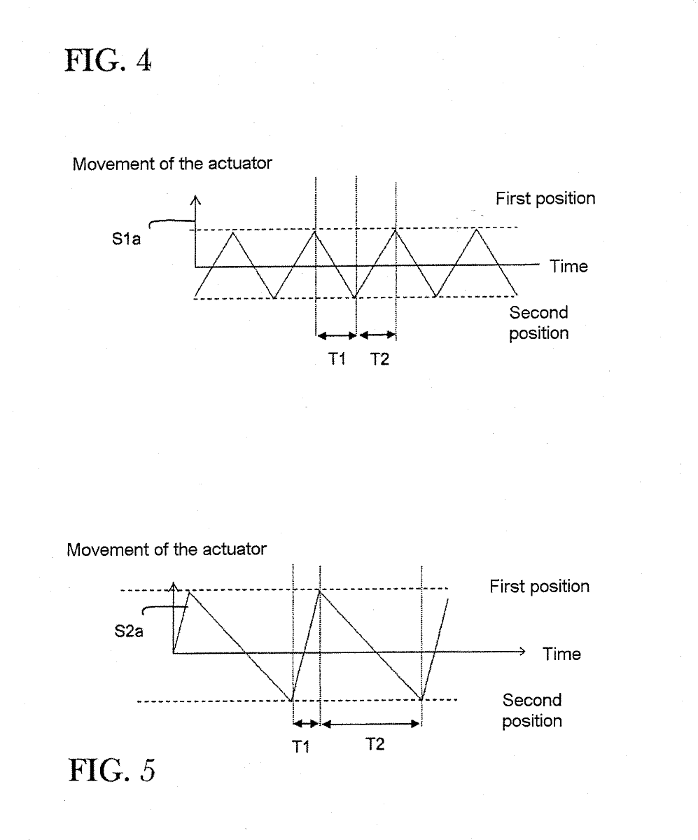

FIGS. 4 and 5 are graphs representing two examples of movements of an actuator over time.

In these figures, the identical elements bear the same reference numbers.

The invention relates to a device for haptic feedback control, for example for a control panel of a motor vehicle, for a touch-sensitive faceplate or else for a touch-sensitive screen that can transmit a haptic feedback to a user having for example modified or selected a command.

As shown in FIG. 1, the device 1 comprises a backing plate 3 for transmitting a haptic feedback to a finger of a user in a circular-shaped zone of movement of a finger, a touch-sensitive surface sensor 5 for detecting a pressure of the finger in the zone and a first and a second actuator 7a, 7b connected to the plate 3 in order to generate the haptic feedback in the zone when a pressure is detected.

The haptic feedback is for example a vibration produced by a sinusoidal control signal or by a control signal comprising one or a succession of pulses.

The actuators 7a, 7b comprise for example a fixed portion and a portion that can move in translation in a gap of the fixed portion, for example of the order of 200 μm, between a first and a second position (not shown).

The movable portion is for example a movable magnet sliding inside a fixed coil or a movable coil sliding around a fixed magnet, the movable portion and the fixed portion interacting by electromagnetic effect.

The movable portion is connected to the plate 3 so that the movement of the movable portion causes the movement of the plate 3 in order to generate the haptic feedback to the finger of the user by the movements D of the actuator in the zone of movement.

The plate 3 has a circular or annular shape containing the zone of circular movement of the finger so as to adjust the dimensions of the plate 3 to the dimensions of the zone of movement of the finger and therefore limit the space requirement of the device.

The movement sensor 5 comprises a touch-sensitive surface sensor supported by the backing plate 3 in the zone of movement of the finger. A touch-sensitive surface pressure sensor, such as a touch-sensitive surface pressure sensor of FSR for “Force Sensing Resistor” technology, that is to say using pressure-sensitive resistors.

These sensors comprise layers of flexible semiconductors sandwiched between for example a conductive layer and a resistive layer. By exerting a pressure or a sliding action on the FSR layer, its ohmic resistance reduces thus making it possible, by the application of an appropriate electric voltage, to measure the pressure applied and/or the location of the place where the pressure is exerted.

According to a different concept of FSR technology, the touch-sensitive sensor comprises two flexible supporting sheets spaced apart from one another by elastic spacers and supporting on faces facing one another elements making it possible to achieve an electric contact when the sensor is compressed.

The actuators 7a, 7b are configured to apply a rotary torque C to the plate 3 in order to generate the haptic feedback in the zone when a pressure is detected, by a pivoting movement of the plate 3 about an axis of rotation I coaxial with the center of the zone of movement of said finger.

In this case, the axis of rotation I has no material axis which makes it possible to limit the interference noise.

According to a first embodiment shown in FIG. 1, the actuators 7a, 7b are placed so as to drive the plate 3 in translation in perpendicular directions D1, D2 and in an appropriate direction for applying a rotary torque C to the plate 3.

According to a second embodiment shown in FIG. 2, the actuators 7a, 7b are placed in a diametrically opposed manner so as to apply a rotary torque C to the plate 3.

In both embodiments, the axis I is formed at the center of the plate 3. The feeling obtained is then uniform for the user in the whole zone of movement of the finger.

FIGS. 3a, 3b and 3c illustrate a control device 1 in operation corresponding to the embodiment of FIG. 2.

Provision is made for one of the two connections between the plate 3 and the movable portion of the actuator 7b to comprise an operating clearance J in radial translation so as not to prevent the plate 3 from pivoting.

For example, the movable portion of each actuator 7a, 7b comprises a support 10a, 10b having for example the shape of a rod, connected to the plate 3. An operating clearance J is provided in radial translation between a support 10b and the plate 3.

Alternatively, provision is made for the device 1 to comprise connection means between the plate 3 and the movable portion of the actuators 7a, 7b made of plastic material.

For example plastic supports 10a, 10b are provided. The compliance of the plastic material is sufficient to absorb the deformations of the connections between the plate 3 and the supports 10a, 10b of the respective actuators 7a, 7b. This embodiment makes it possible to limit the interference noise when the plate 3 pivots.

In operation, the plate 3 pivots about the axis of rotation I between a first position (FIG. 3a) and a second position (FIG. 3c). The FIG. 3b is an intermediate representation.

In FIG. 3a, the movable portions of the actuators 7a, 7b are in abutment in the fixed portions 8a, 8b.

Then, in FIG. 3b, the movable portion of the first actuator 7a moves in translation in a direction D1 and the movable portion of the second actuator 7b moves in translation in a direction D2, parallel to the direction D1, in the opposite direction, so as generate a rotary torque to the plate 3.

Then, in FIG. 3c, the movable portions of the actuators 7a are in abutment in the fixed portions 8a, 8b in second position.

The control signals are periodic. It is also possible to envisage control signals of the pulse type or having frequencies that vary over time.

According to a first variant, the parameters of the control signals are modulated so that the actuators 7a, 7b move-at the same speed in the clockwise direction as in the counterclockwise direction.

FIG. 4 shows a graph of the movement S1a of an actuator over time between a first position and a second position.

The actuator moves over the first half-period T1 from the first to the second position at the same speed as the second half-period T2 from the second to the first position.

Preferably periods T1 and T2 are chosen to correspond to the resonance frequencies of the device 1.

According to a second variant embodiment, the control device 1 comprises a processing unit 9 connected to the sensor 5.

The unit 9 is configured to determine the direction of elementary movement of the finger based on signals originating from the sensor 5, and to modulate at least one control parameter of at least one actuator so that the resultant of the vibratory effect generated by the actuator is felt by the finger in one and the same direction and substantially in the opposite direction to the direction of the elementary movement.

The direction of the elementary movement is for example deduced from two successive items of information of position signals originating from the movement sensor 5.

By applying specific control signals in this way to the actuator, a haptic feedback is generated in the opposite direction which is better perceived by the user.

For example, the parameters of the control signals are modulated so that the actuator moves at a higher speed in the opposite direction to the elementary movement than in the direction of the elementary movement.

FIG. 5 represents an example of a graph of the movement S2a of an actuator over time between a first position and a second position.

Over a period of the back-and-forth movement of the actuator between these two positions, the actuator moves over the first half-period T1 from the second position to the first position much more rapidly and moves more slowly over the second half-period T2 from the first position to the second position.

The more rapid movement of the actuator is more clearly felt by the user than a slower movement. Therefore, the resultant of the vibratory effect generated by the actuator is more clearly felt by the user from the second position to the first position, in the opposite direction to the movement of the finger.

It is thus possible to simulate a mechanical thumbwheel by a flat surface generating a haptic feedback in order, for example, to inform a user of a change of command or of the selection of a command in a drop-down menu, for example in order to inform the user of a change in temperature by a touch-sensitive haptic feedback.

It is understood that by generating a haptic feedback by a pivoting movement of the plate 3 about an axis of rotation I, the user perceives a haptic feedback uniformly in the whole zone of movement of the finger.

1. A control device for haptic feedback control comprising:
a backing plate for transmitting a haptic feedback to a finger of a user in a circular-shaped zone of movement of said finger;
a touch-sensitive surface sensor for detecting a pressure of said finger in said zone;
a first actuator and a second actuator connected to said plate configured to apply a rotary torque to said plate to generate the haptic feedback in said zone when the pressure is detected, by a pivoting movement of said plate about an axis of rotation, coaxial with a center of said zone of movement of said finger.

2. The control device as claimed in claim 1, wherein said plate has a circular or annular shape.

3. The control device as claimed in claim 2, wherein said actuators are placed in a diametrically opposed manner.

4. The control device as claimed in claim 3, wherein one of the two connections between said plate and a movable portion of the actuator comprises an operating clearance in radial translation.

5. The control device as claimed in claim 4, further comprising means for connection between said plate and the movable portion of the actuators made of plastic material.

6. The control device as claimed in claim 1, further comprising: a processing unit connected to said sensor and configured to determine the direction of an elementary movement of said finger based on the signals originating from said sensor, and to modulate at least one control parameter of at least one actuator, so that the resultant of a vibratory effect generated by said actuator is felt by said finger in one and the same direction opposite to the direction of said elementary movement.

7. The control device as claimed in claim 6, wherein said control parameter is modulated so that the actuator moves at a higher speed in the opposite direction to the elementary movement than in the direction of the elementary movement.

8. The control device as claimed in claim 1, wherein the movement sensor comprises a touch-sensitive surface sensor supported by the backing plate in the zone of movement of said finger.

9. The control device as claimed in claim 8, further comprising a touch-sensitive surface pressure sensor of the FSR type.
